(19) United States
(12) Patent Application Publication
(10) Pub. No.: US 2015/0125369 A1
(43) Pub. Date: May 7, 2015

(54) COATED PARTICLE FILTER, CATALYTIC CONVERTER AND DEVICE HAVING THE SAME

(71) Applicant: Bernhard Kahlert, Rietheim (CH)

(72) Inventor: Bernhard Kahlert, Rietheim (CH)

(21) Appl. No.: 14/396,961

(22) PCT Filed: Apr. 26, 2013
(86) PCT No.: PCT/EP2013/058806

§ 371 Date: Jan. 9, 2015

(30) Foreign Application Priority Data
Apr. 26, 2012 (EP) 12165747.2

(51) Int. Cl. B01J 35/02; B01D 53/94; B01J 23/89; B01J 23/44; B01J 23/63

(52) U.S. Cl. CPC B01J 35/02; B01J 23/44; B01J 23/63; B01J 23/8906; B01J 23/8993; B01J 23/8986; B01D 53/9418; B01D 53/944; B01D 53/9477; B01D 2255/1023; B01D 2255/1021; B01D 2255/2063; B01D 2255/2065; B01D 2255/20776; B01D 2255/20761; B01D 2255/20738; B01D 2255/2073; B01D 2255/20723; B01D 2255/20707
USPC 423/213.5; 502/339; 502/303; 502/304; 502/326; 502/309; 502/324; 422/180; 422/171; 55/522

(57) ABSTRACT

The invention relates to a coated particle filter (3), in particular wall-flow filter, having a length (L). According to the invention, at least two zones (4, 5) which have different coatings are provided along the length (L). The invention also relates to a catalytic converter (2), wherein the catalytic converter (2) is formed with a coating which has a washcoat coating layer as a lower coating layer, onto which palladium is deposited. The invention finally relates to a device (1) for the purification of exhaust gases, in particular exhaust gases of diesel-engined motor vehicles, comprising a catalytic converter (2) and a coated particle filter (3) of length (L) positioned downstream of the catalytic converter (2), wherein the particle filter (3) and the catalytic converter (2) are designed in accordance with the invention.

The invention relates to a coated particle filter, in particular a wall-flow filter, having a length. Furthermore, the invention relates to a catalyst which can be flowed through by exhaust gases. Finally, the invention relates to a device for purifying exhaust gases, in particular exhaust gases of diesel-powered motor vehicles, comprising a catalyst and a coated particle filter having a length arranged downstream of the catalyst.

During operation, motor vehicles fueled by gasoline or diesel emit exhaust gases which can contain multiple environmentally hazardous and health-damaging components. These include hydrocarbons (HC), carbon monoxide (CO) and nitrogen oxides (NOₓ). Also, in the case of diesel-powered motor vehicles, soot particles are emitted.

To reduce an emission of hazardous components in exhaust gases of motor vehicles to the greatest possible extent, new exhaust gas standards are constantly enacted by legislators, which standards specify increasingly strict demands in terms of the purity of an exhaust gas. Vehicle and engine manufacturers are therefore forced to provide purifying devices in the exhaust gas systems of motor vehicles, which devices ensure compliance with the applicable exhaust gas standard.

For approximately two decades, there have been considerable efforts on the part of the automotive industry to purify motor vehicle exhaust gases in the exhaust gas system of a motor vehicle. For diesel-powered motor vehicles, a purifying device composed of two components was developed which can be installed into an exhaust gas system or is integrated into such a system. This purification device is known as the continuous regeneration trap system (CRT system). A first component comprises a catalyst that is coated such that nitrogen monoxide (NO) present in the exhaust gas is oxidized to nitrogen dioxide (NO₂). A second component is arranged downstream which is used as a particle filter and filters out soot particles present in the exhaust gas. The soot particles filtered out at the particle filter are converted with the NO previously formed at the catalyst or already present in the exhaust gas by means of a burning of the soot particles, wherein NO₂ is reduced to NO. With a device of this type, soot particles can generally be suitably removed from an exhaust gas of a diesel-powered motor vehicle. A CRT system of this type can be regenerated passively or autonomously, provided that necessary temperatures for a burning of the soot particles are present. Additionally, it can be provided that the particle filter can be actively regenerated, for example, by an injection and combustion of fuel ahead of the catalyst, in order to heat up the particle filter and thus attain the necessary temperatures for the burning of the soot particles. This is primarily necessary when a motor vehicle is operated in a stop-and-go manner, as this is often the case in urban traffic. In this case, the particle filter normally does not reach the necessary temperatures for an autonomous soot burn-off. Even though a CRT system can effectively remove soot particles, carbon monoxide and hydrocarbons from an exhaust gas, nitrogen oxides and, in particular, a high amount of NO₂ still remain.

Exhaust gas purifying devices which operate using selective catalytic reduction (SCR) are also known. In systems of this type, a urea solution is normally injected ahead of a catalyst located in the exhaust gas system. The injected urea solution breaks down, which produces ammonia that reacts with NO and NO₂ at the catalyst so that the NOₓ amount is reduced. Typically, a slip catalyst is also provided for this purpose at the end of the purification device, which catalyst is used to convert excess ammonia, which would otherwise be emitted. SCR systems are normally used on diesel-powered motor vehicles, but this leads to a very complex design of a purifying device with many components.

For diesel-powered motor vehicles, it is known from the prior art that CRT systems not only filter out soot particles, but also markedly reduce HC amounts and CO amounts. Furthermore, the NO₂ proportion of the total amount of NOₓ is reduced to a minimum. For this purpose, a special coating of a particle filter provided in combination with an upstream catalyst is necessary, as this is disclosed in EP 2 335 809 A1. Even if virtually all harmful components of an exhaust gas of a diesel-powered motor vehicle can thereby be removed, it is nevertheless disadvantageous that the NOₓ amount remains nearly constant, since NO₂ is reduced to NO. Therefore, although current exhaust gas standards that provide specific limits for NO₂ amounts are satisfied, future exhaust gas standards that also prescribe stricter limits for NO amounts are not.

The object of the invention is to disclose a particle filter of the type named at the outset which is constructed in simple manner, but which enables an effective purification of an exhaust gas of a motor vehicle, in particular of a diesel-powered motor vehicle.

Another object of the invention is the disclosure of a catalyst of the type named at the outset, which enables an effective exhaust gas purification, in particular working in tandem with a downstream particle filter.

Another additional object of the invention is the disclosure of a device of the type named at the outset with which an exhaust gas of a motor vehicle, in particular of a diesel-powered motor vehicle, can be purified in an especially effective manner.

The first object of the invention is attained in that, with a particle filter of the type named at the outset, at least two zones are provided along the length that are differently coated.

By means of the zonally different coating of a particle filter provided according to the invention, different regions on the filter can be created which respectively perform different functions in regard to an exhaust gas purification or which respectively remove and/or convert a specific component from the exhaust gas in a selective manner. It is thus possible, in particular with an upstream catalyst, to remove many environmentally hazardous components of a motor vehicle exhaust gas with a simple design.

In principle, any number of zones can be provided, for example, three or more zones. However, the particle filter can be coated in a particularly simple manner if two zones are provided, since the particle filter can then be coated in a dipping process. For this purpose, the particle filter only needs to be dipped into an immersion bath up to a predefined portion of its length in order to coat the first zone. The particle filter is subsequently rotated 180° and dipped again into a different immersion bath to create a coating in the second zone, wherein the filter is dipped to the length over which it is not yet coated. The second zone is thereby embodied as a zone which at least partially reduces NO. This makes it possible to catalytically burn soot particles in the first zone, whereas NO present or formed in the second zone is at least partially reduced.

It is particularly preferable that the first zone has a coating containing platinum and/or palladium. Platinum is thereby used to oxidize NO to NO₂, which is necessary for a burning of soot particles. The palladium is attributed with the effect that it, in contrast to platinum, reduces NO₂ to NO. When present at the same time, which can be provided, the two metals thus produce inherently opposite effects. Despite this, an excellent soot burn-off is observed in practice. The exact causes of this with the combined use of platinum and palladium in the coating are not yet clear. It is conceivable that, because of the coating produced from a sol or a solution, reactive metal particles are deposited which effectively serve as microcenters for a catalytic reaction, wherein an oxidation of NO to NO₂ repeatedly occurs, or a reduction in the opposite direction, at the individual centers. In particular, it is also possible, however, that the coating only contains palladium and not platinum and/or other metals. It was possible to achieve surprisingly good results with this version solely based on palladium.

Furthermore, it is advantageous if the first zone comprises a bottom coating layer which is embodied as a washcoat coating layer and onto which a top coating layer containing platinum and/or palladium is deposited. The washcoat coating layer thereby facilitates a good adhesion of the metallic coating or metal particles to the particle filter. In this regard, it can particularly be provided that the washcoat coating layer is formed with titanium dioxide, cerium oxide, lanthanum oxide and optionally iron oxide or is composed thereof. A bottom coating layer of this type has proven to be particularly advantageous for a durable loading of the particle filter. It is thereby advantageous that the washcoat coating layer is predominantly coated with titanium dioxide and cerium oxide, while lanthanum oxide and iron oxide can be present in smaller amounts. In particular, it can be provided that the washcoat coating layer contains more than 20 percent by weight (wt %) titanium dioxide and more than 5 wt % cerium oxide.

It is also preferred that the top coating layer essentially does not contain any other transition metals except for platinum and/or palladium. The two metal elements mentioned are sufficient to achieve the effects according to the invention. However, it is clear that production-related contaminations can be present. If both elements are present, a concentration of platinum and palladium relative to one another is thereby chosen such that a concentration of platinum is preferably greater than a concentration of palladium. This has proven to be advantageous in tests and can be explained in that a burning of soot particles is functionally the main focus in the first zone and should therefore outweigh the platinum part, which provides an oxidation of the NO.

A coating of the second zone can be embodied in any desired manner, provided that the effects according to the invention are achieved, in particular that NO is at least partially reduced, in order to reduce an NOₓ amount in the exiting exhaust gas. However, it was shown rather unexpectedly that the second zone can be embodied with only a single-layer coating. The coating of the second zone can thereby contain titanium dioxide, iron oxide, vanadium oxide and tungsten oxide or can be composed thereof. Vanadium oxide and tungsten oxide can also be replaced separately or jointly by manganese oxide and/or copper oxide. If necessary, at least one rare earth metal can also be present. A single-ply coating layer of this type in the second zone ensures an effective NO reduction.

A length of the individual coating sections or of the first zone and the second zone can be fine-tuned to the specific purpose of use. It is advantageous that a length of the first zone is 50% to 200% of a length of the second zone.

The second object of the invention is attained in that a catalyst of the type named at the outset is embodied with a coating that has as a bottom coating layer a washcoat coating layer onto which palladium is deposited.

An advantage of a catalyst according to the invention can be seen in particular in that the catalyst can ensure an effective purification of an exhaust gas working in tandem with a downstream particle filter according to the invention. A reduction of HC amounts, CO amounts and NO₂ amounts is achieved at the catalyst particularly when it is used in an exhaust gas system of a diesel-powered motor vehicle. The hydrocarbons as well as CO are oxidized. At the same time, an amount of NOₓ is reduced by a magnitude of approximately 5%.

Preferably, a concentration of palladium is particularly high at the catalyst and, in relation to a catalyst volume, is preferably more than 150 gm⁻³. Concentrations that are this high have proven to be advantageous in regard to an exhaust gas purification. In particular, palladium can be provided as a single metal, notwithstanding impurities.

Preferably, it is provided that the washcoat coating contains zirconium oxide or is mostly composed thereof. It can thereby be provided that the wash coat coating layer contains more than 50 wt % zirconium oxide and that the remainder is composed of silicon oxide and aluminum oxide.

The catalyst according to the invention is preferably used with a downstream particle filter, but can also be used in an exhaust gas system of an internal combustion engine flowed through by an exhaust gas flow, in particular an exhaust gas system of a diesel engine, wherein a particle filter and/or an SCR device is provided ahead of the catalyst in the exhaust gas system. In this arrangement with an upstream particle filter and/or an upstream SCR device, it is brought to bear that a catalyst according to the invention provides an NO₂ reduction and thus acts as a slip catalyst.

In very general terms, the catalyst can be used in an exhaust gas system of an internal combustion engine flowed through by an exhaust gas flow, in particular an exhaust gas system of a diesel engine, in order to reduce NO₂ amounts in the exhaust gas system.

The other object of the invention is attained if, in a device of the type named at the outset, the particle filter and the catalyst are embodied according to the invention.

A zone coating can thereby also possibly be provided at the catalyst, wherein different zones can be coated with the same materials, but in different concentrations.

An advantage achieved with the device according to the invention can be seen in that HC amounts, CO amounts and soot particles can be effectively removed from an exhaust gas of a diesel-powered motor vehicle and, furthermore, that an NOₓ amount in the exiting exhaust gas is also significantly reduced. Overall, an effective exhaust gas purification is thus ensured.

It is advantageous if an NOₓ storage catalyst is arranged upstream of the catalyst.

Additional features, benefits and effects of the invention follow from the exemplary embodiment described below. The drawings which are thereby referenced show the following:

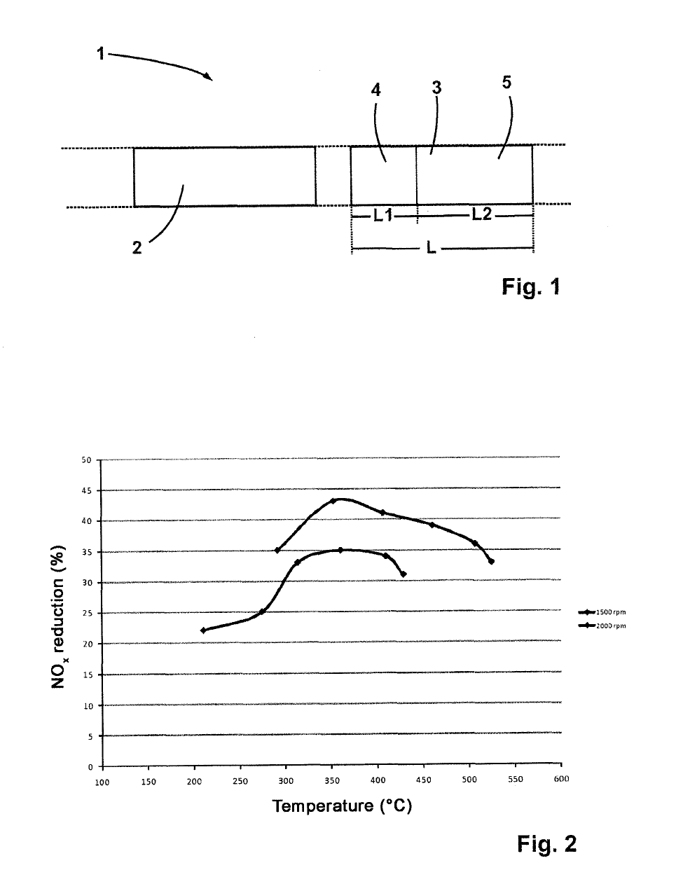

FIG. 1 A schematic representation of a device according to the invention;

FIG. 2 A diagram relating to a reduction of an NOₓ amount in an exhaust gas of a diesel-powered motor vehicle.

In FIG. 1, a schematic design of a device 1 according to the invention is illustrated. The device 1 is typically arranged in a schematically indicted exhaust gas system of a diesel-powered motor vehicle. The device 1 essentially comprises two components, namely a catalyst 2 and a particle filter 3 arranged downstream of the catalyst 2 in the direction of a flowing exhaust gas. The particle filter 3 is of the wall-flow type. This means that it is a filter which is embodied with a plurality of parallel channels extending in the direction of flow of the exhaust gas, wherein the channels at the end of the particle filter 3 are alternatingly closed. However, the flowing exhaust gas can pass through the filter, since the filter is embodied with a porous wall structure in the region of the internal channels, so that the exhaust gas first enters a channel, then passes through a channel wall and finally exits again at the end of the filter. Such components of the wall-flow type are typically made of a ceramic and, as such, are known from the prior art. Nevertheless, the concept according to the invention is not limited to corresponding filters, but rather can also be used if the particle filter 3 is composed of different materials, for example, metal braidings, metal foams or fleeces, which can withstand exhaust gas temperatures of up to approximately 500° C.

The catalyst 2 comprises a basic structure of gas-permeable metal foils or of an, in particular, open-pore ceramic and a washcoat coating layer which has more than 50 wt % zirconium oxide as well as silicon oxide and aluminum oxide as a remainder, wherein a silicon oxide amount exceeds the aluminum oxide amount. A top coating layer which is essentially composed of palladium is deposited onto this bottom washcoat coating layer. The concentration of the palladium is more than 150 gm⁻³.

The particle filter 3 arranged downstream of the catalyst 2 is, as mentioned, of the wall-flow type and comprises a first zone 4 and a second zone 5 which follows downstream. The particle filter 3 has a length L, wherein the first zone 4 extends over a length L1 and the second zone 5 extends over a length L2. In the schematic exemplary embodiment, the lengths L1, L2 combine to form the (total) length L. However, it can also be provided that the first zone 4 is arranged at a distance from the second zone 5, wherein the region between the zones 4, 5 and the zones 4, 5 themselves can be coated. The first zone 4 comprises a bottom coating layer that is embodied as a washcoat coating layer. This bottom coating layer comprises a composition having more than 20 wt % titanium oxide and more than 5% cerium oxide. The remainder of the bottom coating layer is, for example, formed from lanthanum oxide and, optionally, iron oxide. A top coating layer which, aside from contaminations, is only composed of platinum and palladium is deposited onto the bottom coating layer or the washcoat coating layer. A concentration of platinum is thereby approximately equal to up to 2000 gm⁻³, for example. A concentration of palladium is typically smaller than a concentration of platinum and is equal to up to 1500 gm⁻³, for example. In contrast, the second zone 5 only comprises a single coating layer which is composed of titanium dioxide, iron oxide, vanadium oxide and tungsten. A titanium dioxide amount is typically greater than 60 wt %. Iron oxide, vanadium oxide and tungsten oxide are preferably each present in an amount of up to 10 wt %. Vanadium oxide and tungsten oxide can also be replaced separately or jointly by manganese oxide and/or copper oxide, wherein an amount of these alternative components is adjusted accordingly. Furthermore, at least one rare earth metal is also advantageously present in an amount of up to 2 wt %.

In the device 1 illustrated in FIG. 1, the catalyst 2 is primarily used to oxidize HC amounts and to oxidize CO to CO₂. The catalyst 2 can also be used alone as an NO₂ slip catalyst. Through not illustrated, it can be provided that the device 1 additionally comprises a so-called HC dosing system. The HC dosing system is used to inject fuel from the tank of the motor vehicle in order to heat the particle filter 3 as needed by burning the fuel and thus to introduce an active regeneration of the particle filter 3. If an HC dosing system is provided, an injection of the fuel occurs ahead of the catalyst 2 and the particle filter 3. Furthermore, it is also possible that a device 1 illustrated in FIG. 1 comprises an NOₓ storage catalyst which briefly bonds the nitrogen oxides with barium compounds or potassium compounds and is also coated with a noble metal such as platinum. The NOₓ storage catalyst is then preferably arranged ahead of the catalyst 2. Collectively, the NOₓ catalyst and the particle filter 3 are regularly regenerated by means of HC injection.

A device 1 as illustrated in FIG. 1 and having an HC dosing system was studied or tested on an engine test stand with regard to an exhaust gas purification. The tests were performed on an OM 904 LA Mercedes Benz utility vehicle engine. The measured values which can be seen in Table 1 below were thereby obtained.

TABLE 1
Exhaust gas values

| | | | | | | |
|---|---|---|---|---|---|---|
| NOₓ | NO₂ | NO | CO | HC | CO₂ | PM |
| [g/kWh] | [g/kWh] | [g/kWh] | [g/kWh] | [g/kWh] | [g/kWh] | [g/kWh] |

ETC raw emissions

| | | | | | | |
|---|---|---|---|---|---|---|
| 4.069 | 0.120 | 3.949 | 1.878 | 0.085 | 614.15 | 0.092 |

ESC raw emissions

| | | | | | | |
|---|---|---|---|---|---|---|
| 3.873 | 0.149 | 3.724 | 0.546 | 0.057 | 626.05 | 0.072 |

ETC emissions with device 1

| | | | | | | |
|---|---|---|---|---|---|---|
| 2.920 | 0.044 | 2.975 | 0.11 | 0.01 | 623.7 | 0.003 |

ESC emissions with device 1

| | | | | | | |
|---|---|---|---|---|---|---|
| 2.759 | 0.076 | 2.683 | 0.013 | 0.002 | n.a. | 0.0041 |

As can be seen from Table 1, it was possible to significantly reduce the raw emissions in a European Transit Cycle (ETC) and a European Stationary Cycle (ESC). In particular, it is evident from Table 1 that both CO amounts and also HC amounts can be reduced considerably. The same also applies to soot particles (PM), which are essentially completely filtered. Finally, an NOₓ amount is also significantly reduced, wherein both NO₂ amounts and also NO amounts are reduced. Unlike the prior art, the overall content of NOₓ and also NO₂ and NO are each reduced separately in a proportional manner. This is illustrated in FIG. 2 for a further test for different load levels of an engine and over different temperature ranges of the entering gas.

The catalyst 2 and the particle filter 3 can already be present in an exhaust gas system of a motor vehicle on delivery or can also be retrofitted. In both cases, it proves advantageous if the catalyst 2 and the particle filter 3 in the exhaust gas system are mounted on the exhaust gas system using a damping pad or, generally, a damping element. If the catalyst 2 is used or retrofitted as a slip catalyst, it is advantageous if the base body is enclosed by side plates which extend radially and are gas-impermeable. The side plates, which are preferably made of a steel, allow a simple attachment of the catalyst 2 in an exhaust gas system. For this purpose, the exhaust gas system simply needs to be cut open and the catalyst 2 inserted. The side plates then protrude after the exhaust gas system is reconnected and allow a fastening, for example using a clamp guided around the exhaust gas system.

1. Coated particle filter, in particular a wall-flow filter, having a length, characterized in that at least two zones that are differently coated are provided along the length.

2. Coated particle filter according to claim 1, characterized in that a first zone and a second zone are provided, wherein the second zone is an at least NO-reducing zone.

3. Coated particle filter according claim 1, characterized in that the first zone has a coating containing platinum and/or palladium.

4. Coated particle filter according to claim 3, characterized in that the first zone comprises a bottom coating layer which is embodied as a washcoat coating layer and onto which a top coating layer containing platinum and/or palladium is deposited.

5. Coated particle filter according to claim 4, characterized in that the washcoat coating layer is formed with titanium dioxide, cerium oxide, lanthanum oxide and, optionally, iron oxide or is composed thereof.

6. Coated particle filter according to claim 5, characterized in that the washcoat coating layer contains more than 20 wt % titanium dioxide and more than 5 wt % cerium oxide.

7. Coated particle filter according to claim 4, characterized in that the top coating layer does not contain any other transition metals except for platinum and/or palladium.

8. Coated particle filter according to claim 4, characterized in that platinum and palladium are present and a concentration of platinum is preferably greater than a concentration of palladium.

9. Coated particle filter according to claim 1, characterized in that the second zone is embodied with a single-layer coating.

10. Coated particle filter according to claim 9, characterized in that the coating of the second zone contains titanium dioxide, iron oxide, vanadium oxide and tungsten oxide or is composed thereof, wherein vanadium oxide and tungsten oxide can be replaced by manganese oxide and/or copper oxide.

11. Coated particle filter according to claim 1, characterized in that a length of the first zone is 50% to 200% of a length of the second zone.

12. Catalyst, which can be flowed through by exhaust gases, characterized in that the catalyst is embodied with a coating which comprises as a bottom coating layer a washcoat coating layer onto which palladium is deposited.

13. Catalyst according to claim 12, characterized in that the washcoat coating layer contains zirconium oxide or is mostly composed thereof.

14. Use of a catalyst according to claim 12 in an exhaust gas system of an internal combustion engine flowed through by an exhaust gas flow, in particular an exhaust gas system of a diesel engine, wherein a particle filter and/or an SCR device is provided ahead of the catalyst in the exhaust gas system.

15. Use of a catalyst according to claim 12 in an exhaust gas system of an internal combustion engine flowed through by an exhaust gas flow, in particular an exhaust gas system of a diesel engine, to reduce NO₂ amounts in the exhaust gas system.

16. Device for purifying exhaust gases, in particular exhaust gases of diesel-powered motor vehicles, comprising a catalyst and a coated particle filter having a length arranged downstream of the catalyst, characterized in that the particle filter is embodied according to claim 1 and the catalyst is embodied with a coating which comprises as a bottom coating layer a washcoat coating layer onto which palladium is deposited.

17. Device according to claim 16, characterized in that an NOₓ storage catalyst is arranged upstream of the catalyst.
